(19) United States
(12) Patent Application Publication
(10) Pub. No.: US 2024/0218851 A1
(43) Pub. Date: Jul. 4, 2024

(54) HYDROPNEUMATIC ISOTHERMAL COMPRESSED AIR ENERGY STORAGE

(71) Applicant: Shahriar Eftekharzadeh, TORRANCE, CA (US)

(72) Inventor: Shahriar Eftekharzadeh, TORRANCE, CA (US)

(21) Appl. No.: 18/434,266

(22) Filed: Feb. 6, 2024

(51) Int. Cl. F03B 13/06

(52) U.S. Cl. CPC F03B 13/06; F05B 2210/11; F05B 2210/12; F05B 2260/422

(57) ABSTRACT

An apparatus for compressed gas energy storage and recovery.

### FIELD OF THE INVENTION

The present invention is in the field of methods and devices for storing and recovering electrical energy using compressed gas. More specifically, the present invention discloses an improved apparatus for near-isothermal gas compression and expansion in a closed vessel for electrical energy storage and generation.

### BACKGROUND OF THE INVENTION

The ability to store electrical energy is widely recognized as a key limiting factor in the widespread use of renewable energies such as wind and solar, which are intrinsically intermittent in their supply capabilities. Electricity storage is also recognized as a necessity in an electrical grid to store excess (base) supply during hours of low demand for release during hours of high (peak) demand.

U.S. Pat. No. 9,787,161 B2 discloses a method for near-isothermal gas compression and expansion in a closed vessel for Compressed Air Energy Storage (CAES). The method provides for the efficient storage of vast amounts of electrical energy in the form of compressed gas, and recovery of the stored energy via electrical power generation. However, the various embodiments of the invention disclosed in U.S. Pat. No. 9,787,161 B2 only utilize direct mechanical means for power transmission to compress the gas and recover the stored energy.

The power transmission trains disclosed U.S. Pat. No. 9,787,161 B2, incorporate gears, shafts, and screws that operate under large forces and are thus susceptible to fatigue and potential excessive wea that limit the number of charge and discharge cycles and affect system reliability. The required materials must be ultra-high quality with very low tolerances, the procurement and manufacturing of which may entail significant costs negatively affecting the market competitiveness of the systems. These constraints limit the potentials of the disclosed apparatus.

Therefore, there is a need for improved apparatus that utilizes other means of power transmission for gas compression and stored energy recovery, for near-isothermal gas compression and expansion in a closed vessel method disclosed in U.S. Pat. No. 9,787,161 B2. Such improved apparatus would facilitate the realization of the full potentials of the near-isothermal gas compression and expansion method disclosed in U.S. Pat. No. 9,787,161 B2.

### SUMMARY OF THE INVENTION

The present invention provides a solution for the above stated need with hydraulic means of gas compression and energy recovery. The hydraulic means eliminate the need for gears, shafts, and screws to transmit power for gas compression and stored energy recovery, for near-isothermal gas compression and expansion in a closed vessel. Instead of an underground cylinder and piston arrangement disclosed in U.S. Pat. No. 9,787,161 B2, the present invention utilizes an underground hydraulic accumulator that is in thermal communication with surrounding geologic formation. The accumulator serves the exact same purpose as the “cylinder” of the invention disclosed in U.S. Pat. No. 9,787,161 B2 in that it possesses adequate confining strength to withstand the internal pressure and external ground forces, and simultaneously serves as the storage tank for the compressed gas and means of heat transfer to and from the surrounding underground environment to maintain near-isothermal conditions during gas compression and expansion. However, the present invention replaces the “piston” disclosed in U.S. Pat. No. 9,787,161 B2 with hydraulic fluid as the means for power transmission during both gas compression and stored energy recovery. This eliminates the gears, shafts, and screws disclosed in U.S. Pat. No. 9,787,161 B2. The improvement also makes it possible for the apparatus to utilize non-prismatic, irregular-shaped hydraulic accumulators instead of cylindrical shape only. This is highly significant since it opens the door to utilizing both naturally occurring and excavated underground caverns for energy storage and recovery.

As with the cylinder of the invention disclosed in U.S. Pat. No. 9,787,161 B2, the accumulator of the present invention is initially charged with a certain mass of gas such as clean dry air, which raises its initial internal pressure to a certain level at ambient temperature. This constitutes the initial state (pressure, volume, and temperature) of the gas inside the accumulator. The mass of the initial gas introduced inside the accumulator comprises the entire mass of the working gas needed for the amount of energy to be stored meaning that there is no addition of gas to the accumulator during the energy storage (compression) and recovery (expansion) cycle, thus making the system entirely closed.

The present invention utilizes at least one hydraulic pump that forces a liquid such as water or oil into said accumulator via a conduit in order to further compress the gas from initial state to final state, and thereby store the electrical energy supplied to said pump inside said accumulator in the form of compressed gas energy. The stored energy is later recovered by allowing said liquid, which is under the same pressure as said compressed gas, to flow out via a conduit and operate at least one hydraulic generator, thereby resulting in said gas expanding back to the initial state. The liquid needed for the process is stored in a reservoir either at ground level or underground at a certain design elevation with respect to said accumulator. The ground-level reservoir may be a pool, pond, or a tank while the underground reservoir may be a drilled shaft(s), a bored tunnel(s), or a naturally occurring formation such as an aquifer or oil formation.

The maximum rate of gas compression and expansion is predetermined by the maximum rate of power input and output for the particular size accumulator. In order to assure near-isothermal conditions for a given mass and volume of gas, the accumulator of the present invention is geometrically configured as a heat exchanger such that the rate of compression and expansion corresponding to the input and output power ratings respectively do not result in heat generation and cooling rates in excess of the available rate of heat transfer and exchange with ambient environment across the accumulator perimeter contact area, thus maintaining the temperature of gas and accumulator practically constant, resulting in a near-isothermal process.

The present invention may control the heat exchange capability across the accumulator via the shape of the accumulator as it affects the surface area to internal volume ratio. Long slender accumulators provide higher surface area to internal volume ratio that facilitates heat exchange. The placement of the accumulator underground provides an environment of relatively high thermal conductivity with infinite mass that acts as heat sink during compression and heat source during expansion, thus facilitating isothermal conditions.

The underground accumulator may be horizontal, such as a bored cylindrical tunnel of certain diameter and length at a certain depth within a particular geologic formation that together with any lining provides the required confining strength to withstand the aforementioned internal and external forces, or vertical by drilling a shaft of certain diameter and length lined with a casing, which may be of variable thickness and structural strength at different depths in order to provide the required tensile and compressive properties. The underground accumulator may also be an excavated cavern, of either regular or irregular shape, located in a suitable geologic formation, or it may be naturally occurring underground voids such as natural cavern, porous rock formation, confined aquifer, and oil bearing layers, similar to those utilized for storage of natural gas underground. The underground accumulator could also be a cavern developed in an underground salt deposit formation by water injection and dissolved salt removal. However, once completed, the interior of the cavern must be lined to prevent further dissolving and removal of the salt by the working fluid.

The energy storage capability of the accumulator depend primarily on its volume, plus maximum and minimum internal pressures. For excavated accumulators, the former is primarily a function of the diameter and length of the horizontal tunnel(s) and vertical shaft(s), while the latter depends on the properties of the geological formation plus the tensile strength of any casing used. For natural formation accumulators, the size is predetermined by the extent of the confinement layers or size of the cavern developed, and the pressure withstanding capability is set by the physical and structural properties of the geological formation.

It is an object of this invention to provide apparatus that utilizes hydraulic means for the near-isothermal closed-air CAES system disclosed in U.S. Pat. No. 9,787,161 B2, as improved means for storage and recovery of significant amounts of electrical energy.

It is an object of this invention to provide improved elements and arrangements by apparatus for the purposes described thereof, which is comparable in cost with existing systems, dependable, and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of one embodiment of the present invention utilizing a horizontal bored tunnel accumulator plus a ground-level water reservoir.

FIG. 2 is a section view of the embodiment of the present invention in FIG. 1 during energy storage.

FIG. 3 is a section view of the embodiment of the present invention in FIG. 1 during energy recovery.

FIG. 4 is a perspective view of one embodiment of the present invention utilizing a vertical vessel accumulator plus a vertical shaft water reservoir.

FIG. 5 is an elevation section view of the embodiment of the present invention in FIG. 4 during energy storage.

FIG. 6 is an elevation section view of the embodiment of the present invention in FIG. 4 during energy recovery.

FIG. 7 is a perspective view of one embodiment of the present invention utilizing a vertical vessel accumulator plus an underground oil storage tank.

FIG. 8 is an elevation section view of the embodiment of the present invention in FIG. 7 during energy storage.

FIG. 9 is an elevation section view of the embodiment of the present invention in FIG. 7 during energy recovery.

### DETAILED DESCRIPTION

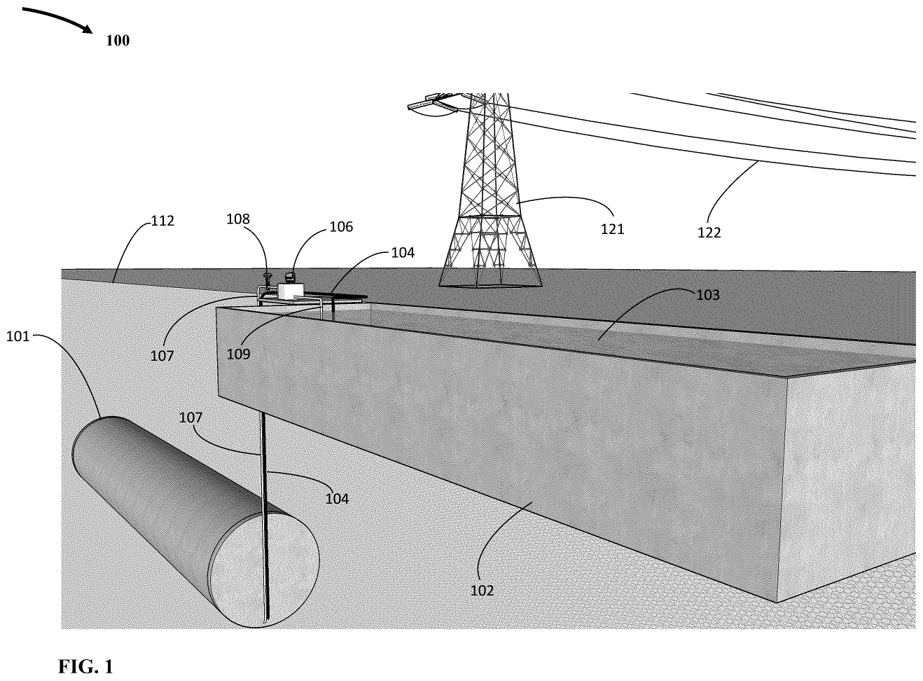

Referring to FIG. 1, there is shown a perspective view of one embodiment of the present invention in the form of apparatus 100 utilizing an underground tunnel accumulator 101 charged with certain mass of gas under pressure, plus a reservoir 102 containing water 103 at near ground level 112. Accumulator 101 is of a certain size and is located at specific depth and location below ground configured to withstand external forces from weight of materials outside and internal forces from pressurization inside.

High-pressure pipe 104, pressurized by at least one pump (not visible) driven by at least one electrical motor and equipped with backflow prevention valve inside reservoir 102, is disposed to convey water 103 from inside reservoir 102 to accumulator 101 to further pressurize the gas inside. High-pressure pipe 107, pressurized by the pressure inside accumulator 101 and equipped with at least one control valve 108, is disposed to convey water from inside accumulator 101 to at least one hydropower generator 106. Apparatus 100 is in proximity of electric utility lines 122 secured by appropriate means such as pylons 121 that supply electrical power to said at least one pump and receive electrical power from said at least one generator 106 via appropriately sized and correctly specified electrical transformers, switches, hardware, and software (not shown).

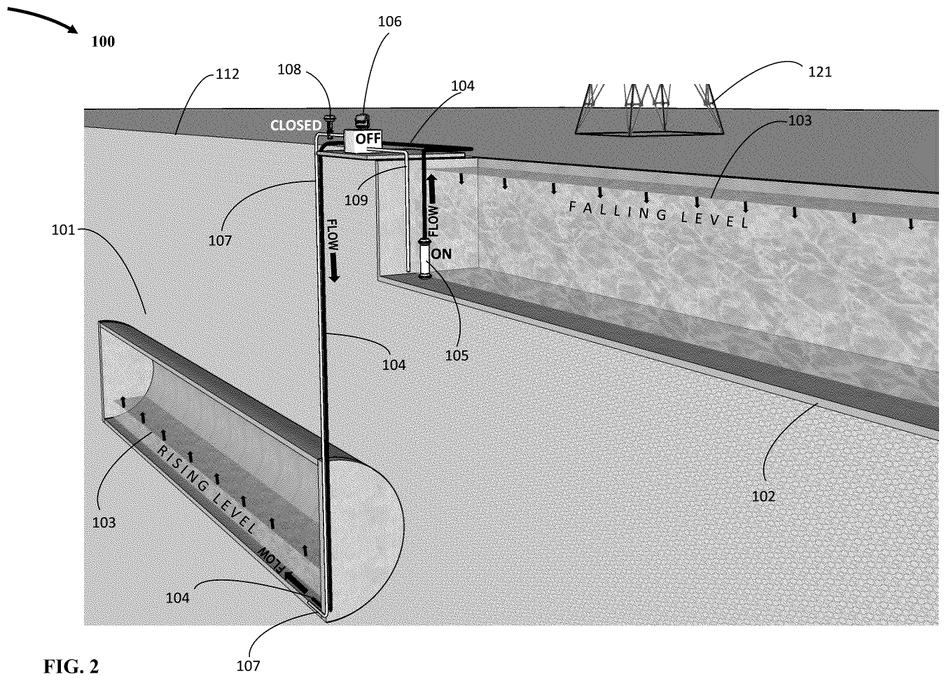

FIG. 2 shows a cut section of the embodiment of the apparatus 100 shown in FIG. 1 during energy storage. Pump 105 is driven by at least one electric motor energized by electrical utility lines (not shown) secured by appropriate means such as pylons 109, is ON to feed water 103 from reservoir 102 into accumulator 101 via high pressure pipe 104. This results in the level of water 103 in reservoir 102 to fall and level of water 103 in accumulator 101 to rise. The latter decreases the head space in accumulator 101, which is occupied by pre-pressurized gas such as air (invisible) and thereby increases the pressure of said gas, which stores energy in the form of compressed gas. Control valve 108 is CLOSED, which stops flow of water 103 from inside accumulator 101 via high-pressure pipe 107 to hydropower generator 106, which is OFF. There is no flow of water 103 from hydropower generator 106 to reservoir 102 via low-pressure pipe 109.

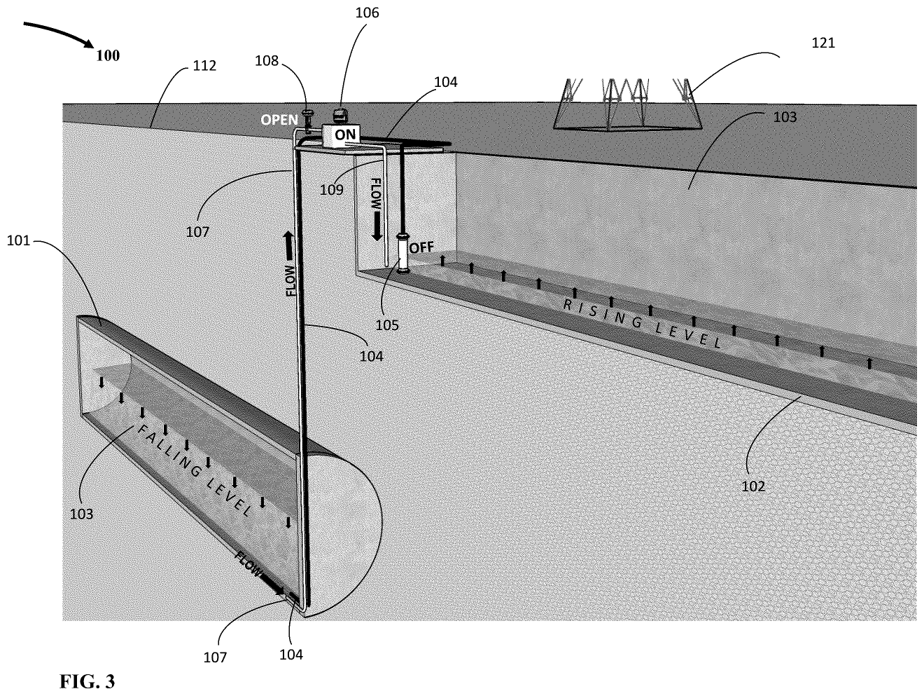

FIG. 3 shows a cut section of apparatus 100 shown in FIG. 1 during energy generation. Pump 105 is OFF, which stops the feeding of water 103 from reservoir 102 into accumulator 101 via high pressure pipe 104, while said backflow prevention valve prevent flow from accumulator 101 back into reservoir 102. Control valve 108 is OPEN, which results in pressurized water 103 in accumulator 101 to be forced out and delivered via high-pressure pipe 107 to hydropower generator 106, which is ON to generate electricity. This results in the level of water 103 in accumulator 101 to fall, which increases the head space in accumulator 101 thereby decreasing the pressure of said gas inside, thus recovering previously stored energy in the form of electricity generated by hydropower generator 106. Low-pressure pipe 109 conveys water from hydropower generator 106 to reservoir 102 under residual pressure, which may be atmospheric resulting in gravity flow, which results in the level of water 103 in reservoir 102 to rise.

In order to accomplish the above-described ON and OFF operations for pump 105 and generator 106, apparatus 100 incorporates appropriately sized and correctly specified sensors, and other monitoring and control hardware and software as required (not shown), which comprise an integral part of the present invention as apparatus 100.

It must be noted that while the embodiment of the present invention as apparatus 100 in FIG. 1, FIG. 2, and FIG. 3, is shown to utilize an underground prismatic accumulator of circular cross section 101, its principals equally apply to any underground void or collection of voids with non-prismatic cross section of various shapes, such as a geological formation that can withstand said external and internal forces, whether naturally occurring or manmade. In addition, while the embodiment of the present invention as apparatus 100 in FIG. 1, FIG. 2, and FIG. 3, is shown to utilize a rectangular shaped ground-level reservoir 102 containing water 103, its principals equally apply to any surface reservoir such as a pond, lake, sea, or ocean, as well as any underground reservoir such as an aquifer, as well as any underground formation containing any suitable liquid such as oil. Arrangements and configurations commonly known in the art would be utilized to adapt the embodiment of the present invention as apparatus 100 in FIG. 1, FIG. 2, and FIG. 3, to said variations of accumulator 101 and reservoir 102.

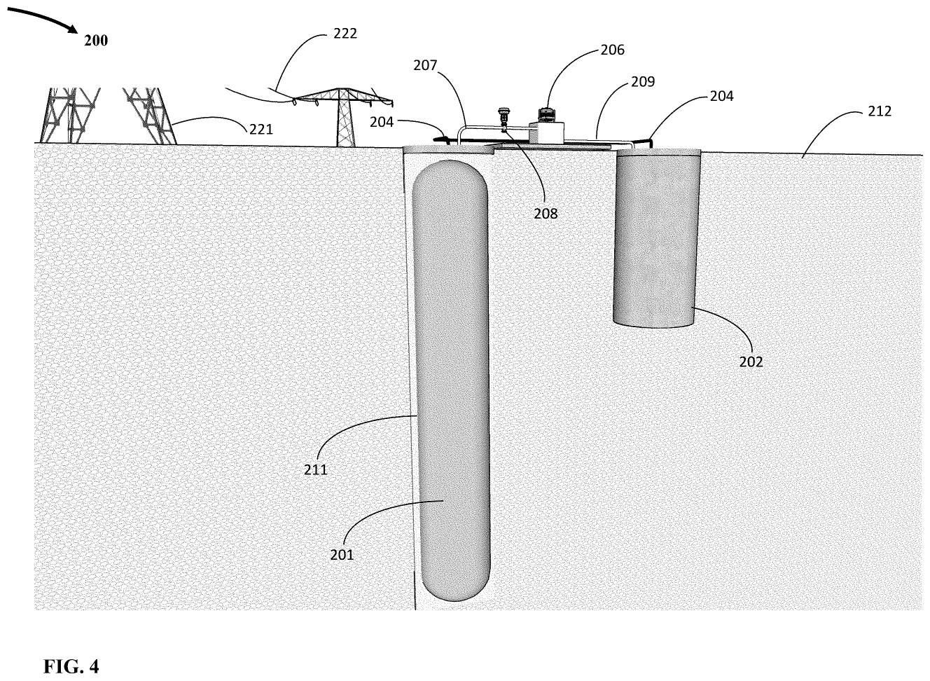

Referring to FIG. 4, there is shown a perspective view of another embodiment of the present invention as apparatus 200 utilizing a vertical underground pressure vessel accumulator 201 charged with certain mass of gas under pressure, plus a vertical underground tank 202 containing water (not visible) below ground level 212. Accumulator 201 is made of appropriate high tensile strength materials such as steel, carbon-fiber, or similar to withstand both internal forces from pressurization inside and external ground pressures. Installation of accumulator 201 may be inside a drilled vertical shaft 211, which may have its annulus backfilled with structural materials to further protect it from external and compressive ground forces.

High-pressure pipe 204, pressurized by at least one pump (not visible) driven by at least one electrical motor and equipped with backflow prevention valve inside tank 202, is disposed to convey water (not visible) from inside tank 202 to accumulator 201 to further pressurize said gas inside. High-pressure pipe 207, under pressure by the pressurized accumulator 201 and equipped with at least one control valve 208, is disposed to convey water from inside accumulator 201 to at least one hydropower generator 206. Apparatus 200 is in proximity of electric utility lines 222 secured by appropriate means such as pylons 221 that supply electrical power to said at least one pump and receive electrical power from said at least one hydropower generator 206 via appropriately sized and correctly specified electrical transformers, switches, hardware, and software (not shown).

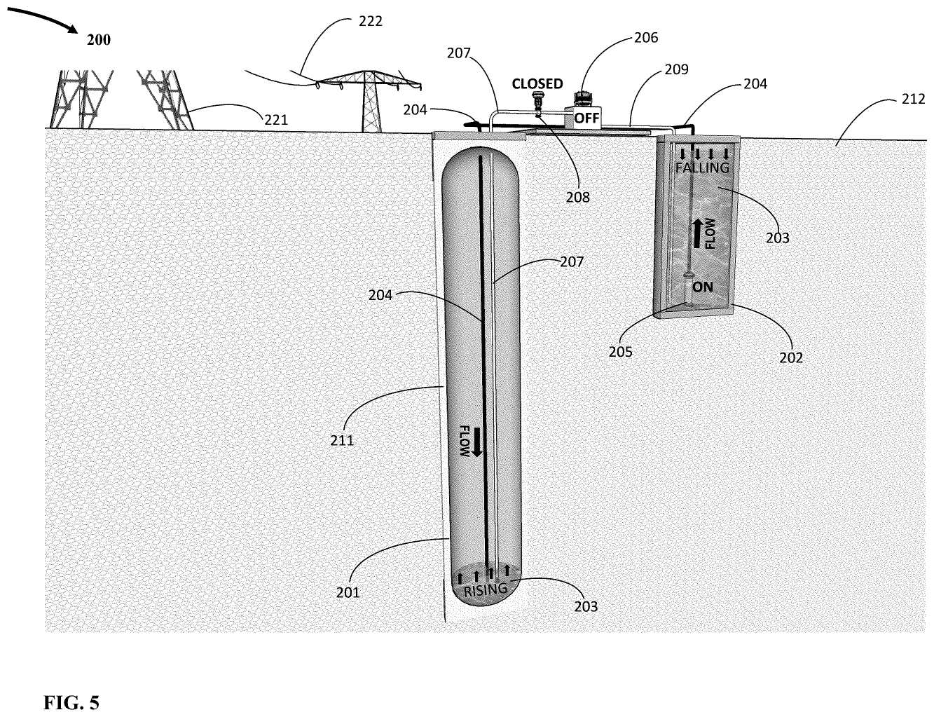

FIG. 5 shows a cut section of apparatus 200 shown in FIG. 4 during energy storage. Pump 205 energized by electrical utility lines (not shown) secured by appropriate means such as pylons 209, is ON to feed water 203 from tank 202 into accumulator 201 via high pressure pipe 204. This results in the level of water 203 in tank 202 to fall and level of water 203 in accumulator 201 to rise. The latter decreases the head space in accumulator 201, which is occupied by pre-pressurized gas such as air (invisible) and thereby increases the pressure of said gas, which stores energy in the form of compressed gas. Control valve 208 is CLOSED, which stops any flow of water 203 from inside accumulator 201 via high-pressure pipe 207 to hydropower generator 206, which is OFF, and there is no flow of water 203 from hydropower generator 206 to tank 202 via low-pressure pipe 209.

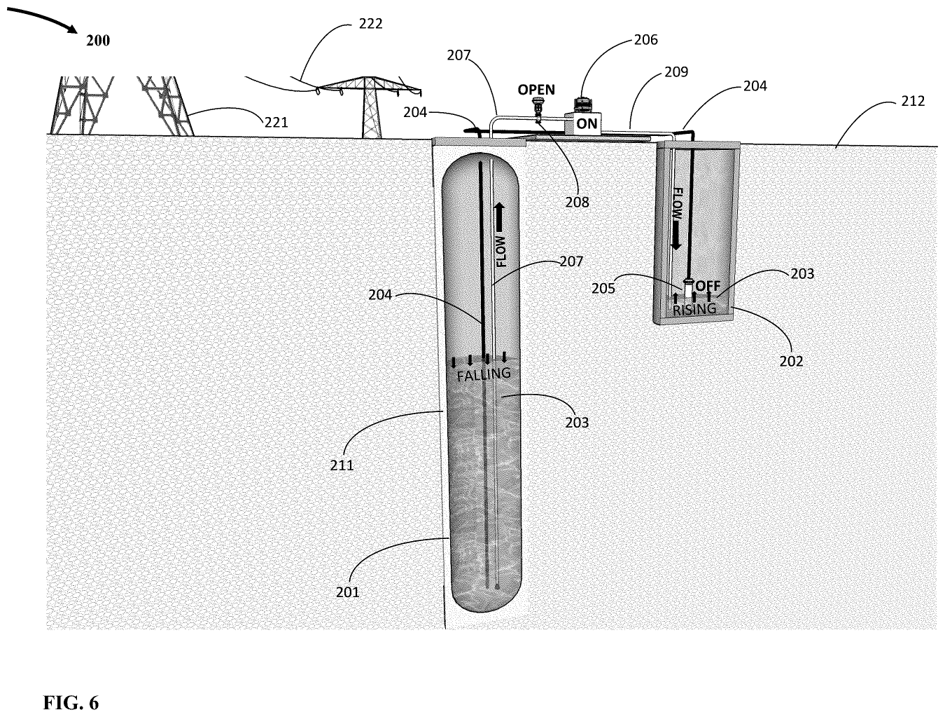

FIG. 6 shows a cut section of apparatus 200 shown in FIG. 4 during energy generation. Pump 205 is OFF, which stops the feeding of water 203 from tank 202 into accumulator 201 via high pressure pipe 204, while said backflow prevention valve prevents flow from accumulator 201 back to tank 202. Control valve 208 is OPEN, which results in water 203 being forced out of accumulator 201 and delivered via high-pressure pipe 207 to hydropower generator 206, which is ON to generate electricity. This results in the level of water 203 in accumulator 201 to fall, which increases the head space in accumulator 201 thereby decreasing the pressure of said gas inside, thus recovering previously stored energy in the form of electricity generated by hydropower generator 206. Low-pressure pipe 209 conveys water from hydropower generator 206 to tank 202 by gravity, which results in the level of water 203 in tank 202 to rise.

In order to accomplish the above-described ON and OFF operations for pump 205 and generator 206, apparatus 200 incorporates appropriately sized and correctly specified sensors, and other monitoring and control hardware and software as required (not shown), which comprise an integral part of the present invention as apparatus 200.

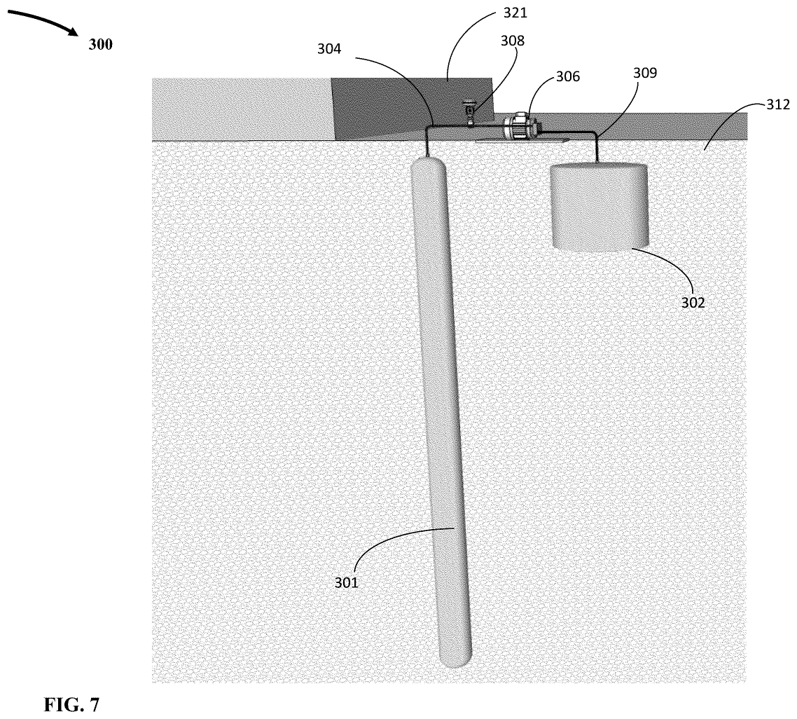

Referring to FIG. 7, there is shown a perspective view of another embodiment of the present invention as apparatus 300 utilizing a vertical underground pressure vessel accumulator 301 charged with certain mass of gas under pressure, plus an underground storage tank 302 containing hydraulic fluid (not visible) such as oil, various mixture of glycol and water, or any other suitable liquid, referred to herein as hydraulic fluid, below ground level 312. Accumulator 301 is made of appropriate high tensile strength materials such as steel, carbon-fiber, or similar to withstand the internal forces from pressurization inside and may be installed in a drilled vertical shaft with annulus backfilled with structural materials to protect it from external compressive forces from ground pressure. Hydraulic pump-turbine coupled with electric motor-generator 306, is connected to high pressure pipe 304 equipped with at least one control valve 308, and to underground storage tank 302.

During energy storage, hydraulic pump-turbine coupled with electric motor-generator 306, receives electrical power from at least one proximate facility 321 via appropriately sized and correctly specified electrical transformers, switches, hardware, and software (not shown), and thus said electric motor-generator functions as electric motor and said hydraulic pump-turbine functions as hydraulic pump. Control valve 308 is positioned to allow flow to accumulator 301 and hydraulic pump-turbine coupled with electric motor-generator 306 pumps hydraulic fluid (not visible) from inside tank 302 to accumulator 301 via low pressure pipe 309 on suction side and high-pressure pipe 304 on discharge side to further pressurize said gas inside accumulator 301. During energy generation, control valve 308 is positioned to allow flow from inside pressurized accumulator 301 via high-pressure pipe 304 to hydraulic pump-turbine coupled with electric motor-generator 306, which functions as hydraulic turbine and rotates said electric motor-generator, which functions as electric generator with the generated electricity transmitted to at least one proximate facility 321 via appropriately sized and correctly specified electrical transformers, switches, hardware, and software (not shown). Hydraulic pump-turbine coupled with electric motor-generator 306 may be substituted for separate hydraulic pump(s) coupled with electric motor(s) and hydraulic turbine(s) coupled with electrical generator(s).

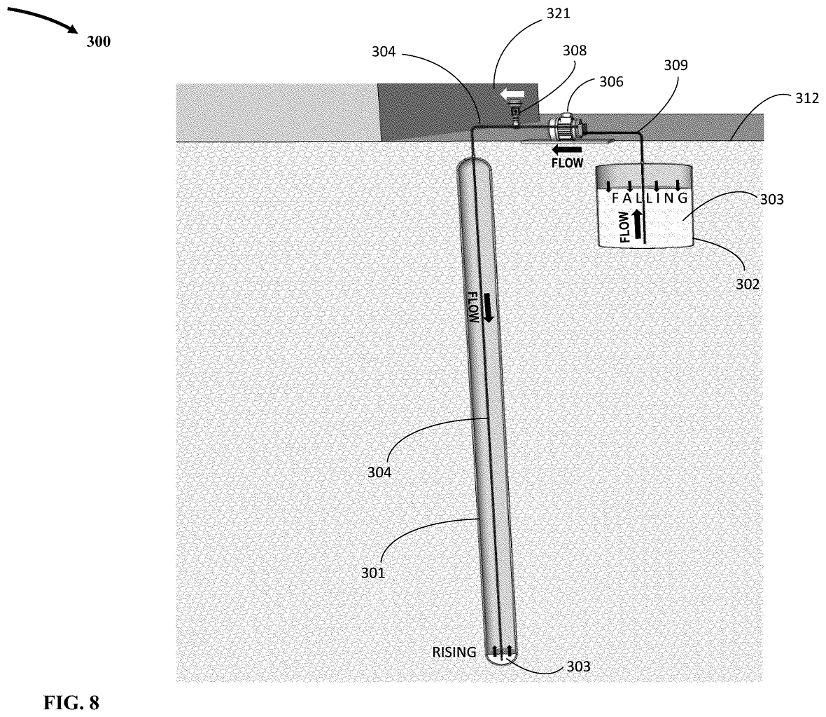

FIG. 8 shows a cut section of apparatus 300 shown in FIG. 7 during energy storage. Control valve 308 is positioned to allow flow to accumulator 301 and hydraulic pump-turbine coupled with electric motor-generator 306 receives electrical power from at least one proximate facility 321 via appropriately sized and correctly specified electrical transformers, switches, hardware, and software (not shown). Said electric motor-generator functions as electric motor and said hydraulic pump-turbine functions as hydraulic pump and hydraulic fluid 303 is pumped from tank 302 into accumulator 301 via low-pressure pipe 309 and high pressure pipe 304. This results in the level of hydraulic fluid 303 in tank 302 to fall and level of hydraulic fluid 303 in accumulator 301 to rise. The latter decreases the head space in accumulator 301, which is occupied by pre-pressurized gas such as air or nitrogen (invisible) and thereby increases the pressure of said gas, which stores energy in the form of compressed gas.

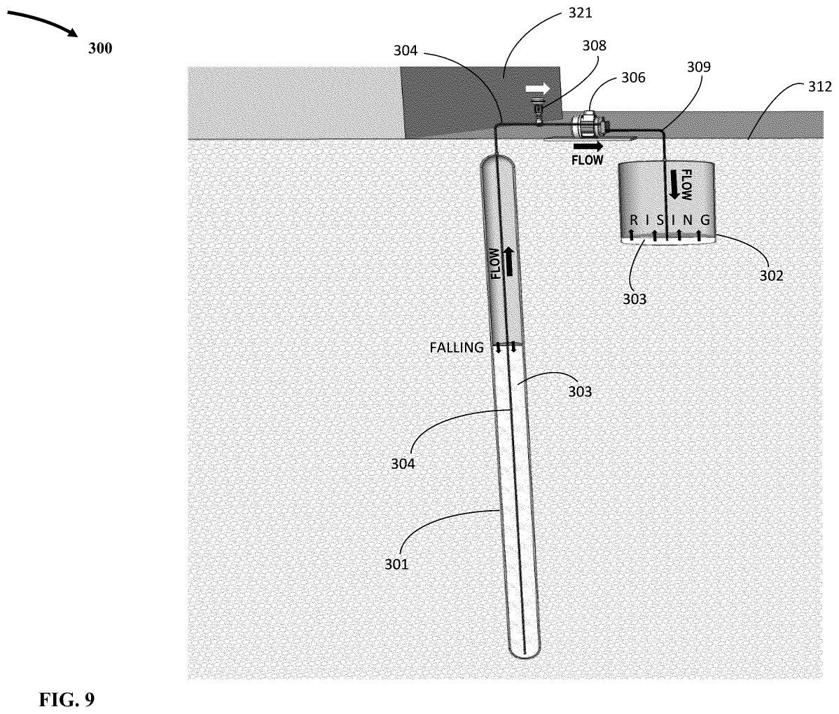

FIG. 9 shows a cut section of apparatus 300 shown in FIG. 7 during energy generation. Control valve 308 is positioned to allow flow from inside pressurized accumulator 301 via high-pressure pipe 304 to hydraulic pump-turbine coupled with electric motor-generator 306, which functions as hydraulic turbine and rotates said electric motor-generator, which functions as electric generator with the generated electricity transmitted to at least one proximate facility 321 via appropriately sized and correctly specified electrical transformers, switches, hardware, and software (not shown). This results in the level of hydraulic fluid 303 in accumulator 301 to fall, which increases the head space in accumulator 301 thereby decreasing the pressure of said gas inside, thus recovering previously stored energy. Low-pressure pipe 309 conveys hydraulic fluid from hydraulic pump-turbine coupled with electric motor-generator 306 functioning as hydraulic generator to tank 302 by residual pressure, which results in the level of hydraulic fluid 303 in tank 302 to rise.

In order to accomplish the above-described operation of hydraulic pump-turbine coupled with electric motor-generator 306 functioning as hydraulic pump and hydraulic generator or is configurations where separate hydraulic machines are used for pumping and generation, apparatus 300 incorporates appropriately sized and correctly specified sensors, and other monitoring and control hardware and software as required (not shown), which comprise an integral part of the present invention as apparatus 300.

The present invention is susceptible to modifications and variations which may be introduced thereto without departing from the inventive concepts and the object of the invention. Configurations other than those described may be used to construct the compressed gas tunnel of the present invention. Also, the term belowground as applicable to the hydraulic accumulator 100 of the present invention shown in FIG. 1, FIG. 2, and FIG. 3 implies confinement by geologic formations and includes accumulators located in mounds, such as mountains and hills, which may be at higher elevation that the surrounding ground. Such modifications and variations do not depart from the inventive concepts and the object of the present invention.

While the present invention has been described in connection with what is considered the most practical and preferred embodiments, it is to be understood that the present invention is not to be limited to the disclosed arrangements but is intended to cover various arrangements which are included within the spirit and scope of the broadest possible interpretation of the appended claims so as to encompass all modifications and equivalent arrangements which are possible.

I claim:

1. An apparatus for compressed gas energy storage and recovery, apparatus comprising:
at least one accumulator disposed underground configured to withstand internal forces from pressurization inside and external forces from weight of materials outside, said accumulator charged with certain mass of gas under pressure;
at least one reservoir disposed to supply liquid to said accumulator and receive liquid from said accumulator;
at least one hydraulic pump disposed to pump said liquid from said reservoir to said accumulator via at least one conduit to reduce volume occupied by said gas inside said accumulator and thus increase pressure inside said accumulator, said hydraulic pump driven by at least one electric motor ultimately energized by said energy to be stored;
at least one generator disposed to generate electricity from said liquid pressurized by said gas inside said accumulator, said liquid conveyed from said accumulator to said generator via at least one conduit and from said accumulator back to said reservoir via at least one conduit,
at least one control valve disposed to prevent flow from said accumulator to said reservoir.

2. The apparatus of claim 1, wherein said liquid is water.

3. The apparatus of claim 1, wherein said gas is air.

4. The apparatus of claim 1, wherein said accumulator is prismatic.

5. The apparatus of claim 1, wherein said accumulator is substantially horizontal.

6. The apparatus of claim 1, wherein said accumulator is non-prismatic.

7. The apparatus of claim 1, wherein said accumulator is an underground cavern.

8. The apparatus of claim 1, wherein said accumulator is a natural underground formation.

9. The apparatus of claim 1, wherein said accumulator is substantially vertical.

10. The apparatus of claim 1, wherein said reservoir is a body of water with surface at ground level.

11. The apparatus of claim 1, wherein said reservoir is an aquifer.

12. The apparatus of claim 1, wherein said reservoir is an oil bearing underground formation.

13. The apparatus of claim 1, wherein said accumulator is a pressure vessel made of high tensile materials.

14. The apparatus of claim 1, wherein said reservoir is an underground storage tank.

15. The apparatus of claim 1, wherein said liquid is a mixture of glycol and water.

16. The apparatus of claim 1, wherein said liquid is oil.

17. The apparatus of claim 1, wherein said gas is nitrogen.
